(19) United States
(12) Patent Application Publication
(10) Pub. No.: US 2002/0091652 A1
(43) Pub. Date: Jul. 11, 2002

(54) System and methods for providing a billing system for use in a content distribution service

(75) Inventor: Atsushi Nagahara, Chino-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 10/026,910

(22) Filed: Dec. 27, 2001

(30) Foreign Application Priority Data
Jan. 5, 2001 (JP) 2001-000386

(51) Int. Cl. G06F 17/00

(52) U.S. Cl. 705/400

(57) ABSTRACT

To provide a billing system for use in a content distribution service, in which a digital content requested by a user is provided to the user in accordance with a payment condition specified by the user without causing an unexpectedly high fee to be charged to the user. [Solving Means] In retrieval of digital contents, digital contents are selected such that the total fee for the digital contents to be selected does not become greater than the sum of the maximum value indicated by a user profile table 300 and the total discount value associated with selected advertisement information. In retrieval of advertisement information, advertisement information is selected such that the total fee for the selected digital contents does not become greater than the sum of the maximum value indicated by the user profile table 300 and the total discount value associated with the additional information to be selected.

### BACKGROUND OF THE INVENTION

1. Field of Invention

The present invention relates to a system, a method, and a storage medium, by which when advertisement information is attached to a digital content provided to an user, part of a payment value charged to the user is distributed to an advertiser, and more particularly, to a debt distribution system, a billing system, a debt distribution method, and a storage medium in which a debt distribution program is stored, suitable for use in a content providing service in which a digital content requested by a user is provided to the user in accordance with a payment condition specified by the user without causing an unexpectedly high fee to be charged to the user.

2. Description of Related Art

A system is known in which when information is displayed on a user terminal, advertisement information is attached to the information displayed on the user terminal and an information/communication service fee (such as a fee for connection with the Internet) charged to the user is partially paid by an advertiser. Technologies relating to such a system may be found, for example, in Japanese Unexamined Patent Application Publication No. 6-46175 entitled “Billing System in Multimedia Communications”, Japanese Unexamined Patent Application Publication No. 8-130579 entitled “Communications Network Having the Capability of Providing Communications Service in which Transmission of Advertisement Is Allowed”, Japanese Unexamined Patent Application Publication No. 2000-151811 entitled “Internet Connection Apparatus”, Japanese Unexamined Patent Application Publication No. 9-90832 entitled “Image Forming Apparatus”, Japanese Unexamined Patent Application Publication No. 9-114755 entitled “Information Billing System”, Japanese Unexamined Patent Application Publication No. 11-85785 entitled “Information Processing Method” and Japanese Unexamined Patent Application Publication No. 8-195834 entitled “Information Billing System”.

In the billing system in a multimedia communications system disclosed in Japanese Unexamined Patent Application Publication No. 6-46175 (hereinafter, referred to as the first conventional technology), the billing system includes advertisement information storage means for storing advertisement information to be provided by one or more advertisers to a subscriber terminal in the multimedia communications system; advertisement information combining means for adding advertisement information to communication information to be transmitted between subscriber terminals; measurement means for measuring the degree to which advertisement information is provided to at least one of subscriber terminals that communicate with each other; database means for storing billing information used to bill communication between subscriber terminals; and call control means for calculating the fee for communication between subscriber terminals in accordance with the billing information stored in the database means and in accordance with the degree, measured by the measurement means, to which advertisement information is provided, such that part of the fee is paid by the advertiser.

In the communications network having the capability of providing communications service in which transmission of advertisement is allowed, disclosed in Japanese Unexamined Patent Application Publication No. 8-130579 (hereinafter, referred to as the second conventional technology), the communications network includes an exchange connected to a plurality of terminals or trunk lines; advertisement information providing means, disposed in the communications network, for transmitting advertisement information provided by an advertiser to terminals such that at an arbitrary time in communication, such as a time just before the start of the communication, advertisement information is transmitted to the terminals in a predetermined period or a predetermined amount of advertisement information is transmitted to the terminals, in response to a request; and billing means for charging at least part of the communication fee to the advertiser.

In the Internet connection apparatus disclosed in Japanese Unexamined Patent Application Publication No. 2000-151811 (hereinafter, referred to as the third conventional technology), a user accesses a charged-to-receiver telephone number that is opened to the public in accordance with authentication information that is opened by an advertiser to the public, using user terminal. An Internet connection apparatus using that telephone number as a free access point allows a terminal, which logs in to the free access point via the dial-up IP connection, to get access to only a WWW server managed by the advertiser. The Internet connection apparatus records the connection history and charges the advertiser the fee for the charged-to-receiver telephone connection and the fee for the Internet connection.

In the image forming apparatus disclosed in Japanese Unexamined Patent Application Publication No. 9-90832 (hereinafter, referred to as the fourth conventional technology), a blank area detection unit detects a blank area in a document image inputted via an image input unit, a controller acquires, from an advertisement image storage unit, an advertisement image that matches the detected blank area, an image combining unit combines the advertisement image with the document image, and an image output unit outputs the resultant image. If no blank area is found or if attachment of an advertisement image is not allowed, the document image is directly outputted.

In the case where a command indicating that a plurality of copies should be made is inputted via a selection command input unit, a controller divides the number of pages included one copy by the number of copies, adds the integral part of the resultant quotient to the number of combined-image pages counted by an advertisement image copy counter, and distributes the fee to a user and an advertiser in accordance with the resultant sum and the total number of outputted image pages counted by a usual copy counter.

In the billing system disclosed in Japanese Unexamined Patent Application Publication No. 9-114755 (hereinafter, referred to as the fifth conventional technology), when advertisement information is included in an information label of the information to be used, an information body processor calls an advertisement selector to request a user to input a command indicating whether attachment of an advertisement is allowed and to request the user, if attachment of an advertisement is allowed, to select any of a plurality of advertisements. If the information body processor receives the selection result, the information body processor transfers it to an advertisement display unit and starts a process concerning an information body. The advertisement display unit presents the selected advertisement to the user. When the use of the information is ended, a fee calculation unit receives, from the information body processor, information needed to calculate the fee, calculates the fee for the use of the information taking into account the advertisement selection result, and outputs the calculation result together with an information identifier.

In the case where the advertisement was presented to the user, the fee is discounted.

In the information processing method disclosed in Japanese Unexamined Patent Application Publication No. 11-85785 (hereinafter, referred to as the sixth conventional technology), retrieval can be performed in accordance with various kinds of retrieval information relating to information to be downloaded. In particular, when information to be downloaded is determined in accordance with retrieved information, if the retrieved information is outputted as an advertisement to a user, the fee for the downloaded information is discounted by an amount depending upon the advertisement.

In the information billing system disclosed in Japanese Unexamined Patent Application Publication No. 8-195834 (hereinafter, referred to as the seventh conventional technology), an information providing terminal determines the discount rate in accordance with data stored in a distribution history storage unit and indicating the number of pieces of music distributed in a previous month, multiplies the total fee for music to be transmitted to a user by the determined discount rate, and employs the resultant value as a fee to be actually charged to the user. Billing is then performed via a billing communication network in accordance with the finally determined value of the fee.

In recent years, a service has become popular in which a digital content such as news is distributed by electronic mail. In this news distribution service, user's preference in terms of the category may be registered in a distribution server so that a digital content of news in the category specified by the user is transmitted to the user terminal from the distribution server.

In a pay news distribution service, the fee for transmission of news to be paid by a user may be calculated in various manners. For example, a predetermined fixed amount may be charged for transmission of news in a predetermined period, or the fee may be charged depending upon the number of transmitted contents or the data sizes thereof and/or depending upon the freshness or the category of the digital contents. In the case where a fixed amount is charged, a user can know how much fee will be charged to the user, and thus no problems occur. However, in the case where the fee is charged depending upon the amount of transmitted information, there is a possibility that an unexpectedly high fee is charged to a user. In the case of telephone communication or Internet connection service, even if the fee is charged depending upon the amount of information, there is little possibility that an unexpectedly high fee for telephone connection or Internet connection is charged to an user, because the user can know how often or how many hours the user has used the telephone or the Internet. In contrast, in the case of the news distribution service that is charged depending upon the amount of information provided, even if the user is informed, in advance, of the method of calculating the fee, it is difficult for the user to directly estimate the fee for a received digital content, and thus there is a possibility that an unexpectedly high fee is charged.

One of the first to seventh conventional technologies may be applied to a news distribution service so that advertisement information is attached to a digital content and the fee is discounted thereby preventing the user from being charged an unexpected high fee. Another way is to set an upper limit in the value to be paid by an user so that when the fee has reached the upper limit, no more digital content is transmitted thereby preventing the user from being charged an unexpectedly high fee.

However, in the case where one of the first to seventh conventional technologies is applied, because the fee is discounted by a fixed amount predetermined by the system provider, although it is possible to prevent a user from being charged an unexpectedly high fee as long as the fee is within a small range, there is still a possibility that an unexpectedly high fee is charged as a result of transmission of a high-price digital content.

Moreover, in the case where the upper limit in the payment value is set, the problem is in that any desired digital content is not transmitted once the payment value has reached the upper limit.

In the news distribution service in which the fee is charged depending upon the amount of information provided, some users may prefer that the payment value should be lower than a predetermined upper limit although some digital contents cannot be received, some may prefer to receive all desired digital contents even if the payment value becomes rather high, some may prefer to receive all particular digital contents while maintaining the payment value below the upper limit, some may prefer that the amount of attached advertisement information should be as small as possible although the payment value becomes rather high, and some may prefer that the payment value should be as low as possible although the amount of attached advertisement information becomes very large.

However, in the case where one of the first to seventh convention technologies is simply applied to the news distribution service, or an upper limit is simply set, it is impossible to adjust the billing method and the method of selecting digital contents to be provided in accordance with the user's preference, and it is very difficult to satisfy the desires of all users.

In view of the existing problems in the conventional technologies, it is an object of the present invention to provide a debt distribution system, a billing system, a debt distribution method, and a storage medium in which a debt distribution program is stored, suitable for use in a content providing service in which a digital content requested by a user is provided to the user in accordance with a payment condition specified by the user without causing an unexpectedly high fee to be charged to the user.

### SUMMARY OF THE INVENTION

In accordance with claim 1 of the present invention, in order to achieve the above object, there is provided a system for distributing a debt in a content providing service, the system being communicably connected to content storage means in which one or more digital contents are stored and also communicably connected to additional-information storage means in which additional information offered for being provided by one or more additional-information providers is stored, the system having a capability of distributing a debt such that when additional information is transmitted to an user associated with a digital content, part or all of a debt imposed upon the user as a result of transmission of the digital content to the user is distributed to the additional-information provider of the additional information, wherein the digital content and the additional information are selected from the content storage means and the additional-information storage means in accordance with a selection criterion, in terms of the debt distribution, designated by the user, and part or all of the debt imposed upon the user is distributed to the additional-information provider in accordance with the selection result.

In this system, in accordance with the desire, in terms of debt distribution, of the user, a digital content and additional information are selected from those stored in the content storage means and the additional-information storage means, and the selected digital content and additional information are transmitted to the user. In accordance with the selection result, part or all of the debt resulting from reception of the digital content is distributed to the additional-information provider

Herein, “additional information” refers to information that is offered, by an additional-information provider, for being provided together with a digital content. A specific example of additional information is advertisement information that an advertiser wants to provide. This also holds in a billing system for use in a content distribution service according to claim 2, a method of distributing a debt in a content distribution service according to claim 12, and a computer-readable storage medium in which a debt distribution program for controlling a process in a content distribution service according to claim 13.

A specific example of the debt resulting from reception of a digital content is the fee for the received digital content that should be paid by the user. This also holds in the method of distributing a debt in a content distribution service according to claim 12, and the computer-readable storage medium in which a debt distribution program for controlling a process in a content distribution service according to claim 13.

The present system may be implemented in the form of a single apparatus or in the form of a networked system including a plurality of terminals communicably connected to each other. In the latter case, each constituent element may be included in any one of the plurality of terminals as long as they are communicably connected to each other. This also holds in the billing system for use in a content distribution service according to claim 2.

According to claim 2 of the present invention, to achieve the above-described object, there is provided a billing system for use in a content providing service, the system being communicably connected to content storage means in which one or more digital contents are stored and also communicably connected to additional-information storage means in which additional information offered for being provided by one or more additional-information providers is stored, the system having a capability of distributing a payment value such that when additional information is transmitted to an user associated with a digital content, part or all of the payment value charged to the user as a result of transmission of the digital content to the user is distributed to the additional-information provider of the additional information, the system comprising distribution-manner information storage means for storing distribution-manner information indicating a manner of distributing the payment value, designated by the user; content selection means for selecting a digital content from the digital contents stored in the content storage means; additional-information selection means for selecting additional information from the additional information stored in the additional-information storage means; additional-information linkage means for making a link between the digital content selected by the content selection means and the additional information selected by the additional-information selection means; content transmission means for transmitting the digital content linked to the additional information to the user; and payment value distribution means for distributing part or all of the payment value charged to the user to the additional-information provider, in accordance with the selection result made by the content selection means and in accordance with the selection result made by the additional-information selection means, wherein one or both of the content selection means and the additional-information selection means make a selection in accordance with the distribution-manner information stored in the distribution-manner information storage means and in accordance with a selection result made by the other one of the content selection means and the additional-information selection means.

In this system, the content selection means selects a digital content from those stored in the content storage means and the additional-information selection means selects additional information from the additional information stored in the additional-information storage means. More specifically, in the selection of the digital content and/or the additional information, the selection is made by one or both of the content selection means and the additional-information selection means in accordance with the distribution-manner information stored in the distribution-manner information storage means and in accordance with the selection result made by the other one of the content selection means and the additional-information selection means.

Thereafter, the additional-information linkage means makes a link between the selected digital content and the selected additional information, and the content distribution means transmits the digital content linked with the additional information to the user. The fee distribution means distributes part or all of the fee charged to the user to the additional-information provider, in accordance with the selection result made by the content selection means and in accordance with the selection result made by the additional-information selection means.

The content distribution means may transmit the digital content directly to the user terminal or may store the digital content into storage means that is accessible by the user terminal so that the user can acquire the digital content from the storage means to the user terminal.

The additional-information linkage means may make the link between the digital content and the additional information in an arbitrary fashion as along as the additional information is linked with the digital content. For example, the link may be established by attaching the additional information to the digital content or by attaching the digital content with link information (such as an URL (Uniform Resource Locator)) pointing to the additional information.

The distribution-manner information may be information specifying an upper limit in the payment value, information specifying a selection condition (for example, in terms of the content, aspect, or quality of the additional information or in terms of the amount of information to be linked) associated with additional information, or information specifying a selection condition (for example, in terms of the content, aspect, or quality of the digital content or in terms of the number of digital contents) associated with the digital content.

The distribution-manner information storage means may store distribution-manner information in any possible manner at any possible time. The distribution-manner information may be stored in advance in the distribution-manner information storage means, or, alternatively, distribution-manner information may be stored when the distribution-manner information is inputted from the external during the operation of the system.

According to claim 3 of the present invention, there is provided a billing system for use in a content distribution service based on claim 2, wherein the content storage means stores the digital content such that the digital content is related to digital-content-fee information indicating a fee for the digital content to be paid by the user, and the additional-information storage means stores the additional information such that the additional information is related to discount value information indicating a discount value that will be reduced from the payment value when the additional information is linked to the digital content, wherein one or both of the content selection means and the additional-information selection means make a selection such that the sum of the fee calculated on the basis of the digital-content-fee information or the discount value information corresponding to a selection result made by the other one of the content selection means and the additional-information selection means in accordance with the distribution-manner information stored in the distribution-manner information storage means and the fee calculated on the basis of the discount value information or the digital-content-fee information corresponding to a selection result made by the user meets a condition specified by the user.

In this system, one or both of the content selection means and the additional-information selection means make a selection such that the sum of the fee calculated on the basis of the digital-content-fee information or the discount value information corresponding to a selection result made by the other one of the content selection means and the additional-information selection means in accordance with the distribution-manner information stored in the distribution-manner information storage means and the fee calculated on the basis of the discount value information or the digital-content-fee information corresponding to a selection result made by the user meets a condition specified by the user.

According to claim 4 of the present invention, there is provided a billing system for use in a content distribution service based on claim 3, wherein the distribution-manner information is information indicating a maximum value in terms of the payment value designated by the user, and wherein the content selection means selects the digital content such that the fee calculated on the basis of the digital-content-fee information corresponding to the digital content to be selected by the content selection means does not become greater than the sum of the maximum value indicated by the distribution-manner information and the discount value calculated on the basis of the discount value information corresponding to the additional information selected by the additional-information selection means.

In this system, the content selection means selects the digital content such that the fee calculated on the basis of the digital-content-fee information corresponding to the digital content to be selected by the content selection means does not become greater than the sum of the maximum value indicated by the distribution-manner information and the discount value calculated on the basis of the discount value information corresponding to the additional information selected by the additional-information selection means.

According to claim 5 of the present invention, there is provided a billing system for use in a content distribution service based on claim 3, wherein the distribution-manner information is information indicating a maximum value in terms of the payment value designated by the user, and wherein the additional-information selection means selects the additional information such that the fee calculated on the basis of the digital-content-fee information corresponding to the digital content selected by the content selection means does not become greater than the sum of the maximum value indicated by the distribution-manner information and the discount value calculated on the basis of the discount value information corresponding to the additional information to be selected by the additional-information selection means.

In this system, the additional-information selection means selects the additional information such that the fee calculated on the basis of the digital-content-fee information corresponding to the digital content selected by the content selection means does not become greater than the sum of the maximum value indicated by the distribution-manner information and the discount value calculated on the basis of the discount value information corresponding to the additional information to be selected by the additional-information selection means.

According to claim 6 of the present invention, there is provided a billing system for use in a content distribution service based on claim 4 or 5, wherein the system further comprises fee calculation means for calculating the fee on the basis of the digital-content-fee information corresponding to the digital content selected by the content selection means; and discount value calculation means for calculating the discount value on the basis of the discount value information corresponding to the additional information selected by the additional-information selection means, and wherein the content selection means selects the digital content such that the fee calculated on the basis of the digital-content-fee information corresponding to the digital content to be selected by the content selection means does not become greater than the sum of the maximum value indicated by the distribution-manner information and the discount value calculated by the discount value calculation means, and the additional-information selection means selects the additional information such that the fee calculated by the fee calculation means does not exceed the sum of the maximum value indicated by the distribution-manner information and the discount value calculated on the basis of the discount value information corresponding to the additional information to be selected by the additional-information selection means.

In this system, the content selection means selects the digital content from the digital contents stored in the content storage means, and the fee calculation means calculates the fee on the basis of the digital-content-fee information corresponding to the selected digital content. Furthermore, the additional-information selection means selects the additional information from the additional information stored in the additional-information storage means, and the discount value calculation means calculates the discount value on the basis of the discount value information corresponding to the selected additional information.

More specifically, the content selection means selects the digital content such that the fee calculated on the basis of the digital-content-fee information corresponding to the digital content to be selected does not become greater than the sum of the maximum value indicated by the distribution-manner information and the discount value calculated by the discount value calculation means. In the selection of the additional information, the additional-information selection means selects the additional information such that the fee calculated by the fee calculation means does not exceed the sum of the maximum value indicated by the distribution-manner information and the discount value calculated on the basis of the discount value information corresponding to the additional information to be selected by the additional-information selection means.

According to claim 7 of the present invention, there is provided a billing system for use in a content distribution service based on one of claims 3 to 6, wherein the distribution-manner information is information indicating a selection condition in terms of the additional information designated by the user, the additional-information selection means selects additional information that meets the selection condition indicated by the distribution-manner information, and the fee distribution means determines the payment value to be paid by the user by subtracting the discount value calculated on the basis of the discount value information corresponding to the additional information selected by the additional-information selection means from the fee calculated on the basis of the digital-content-fee information corresponding to the digital content selected by the digital content selection means.

In this system, the additional-information selection means selects additional information that meets the selection condition indicated by the distribution-manner information, and the fee distribution means determines the payment value to be paid by the user by subtracting the discount value calculated on the basis of the discount value information corresponding to the additional information selected by the additional-information selection means from the fee calculated on the basis of the digital-content-fee information corresponding to the digital content selected by the digital content selection means.

According to claim 8 of the present invention, there is provided a billing system for use in a content distribution service based on one of claims 3 to 7, wherein the distribution-manner information is information indicating a digital content selection condition specified by the user, the content selection means selects a digital content that meets the selection condition indicated by the distribution-manner information, and the fee distribution means determines the payment value to be paid by the user by subtracting the discount value calculated on the basis of the discount value information corresponding to the additional information selected by the additional-information selection means from the fee calculated on the basis of the digital-content-fee information corresponding to the digital content selected by the digital content selection means.

In this system, the content selection means selects the digital content that meets the selection condition indicated by the distribution-manner information, and the fee distribution means determines the payment value to be paid by the user by subtracting the discount value calculated on the basis of the discount value information corresponding to the additional information selected by the additional-information selection means from the fee calculated on the basis of the digital-content-fee information corresponding to the digital content selected by the digital content selection means.

According to claim 9 of the present invention, there is provided a billing system for use in a content distribution service based on one of claims 2 to 8, wherein the system further comprises user information storage means for storing user information associated with a user and content layout means for determining an output layout of the digital content linked to the additional information, in accordance with the user information stored in the user information storage means, and laying out the digital content in accordance with the determined output layout, wherein the content distribution means transmits the digital content laid out by the layout means to the user.

In this system, the content layout means determines the output layout of the digital content linked to the additional information, in accordance with the user information stored in the user information storage means, and lays out the digital content in accordance with the determined output layout. The content distribution means transmits the laid out digital content to the user.

The user information storage means may store user information in any possible manner at any possible time. User information may be stored in advance in the information storage means, or, alternatively, user information may be stored when the user information is inputted from the outside during the operation of the system.

The output layout includes a display layout indicating a layout according to which a digital content should be displayed on a screen or a print layout indicating a layout according to which the digital content should be printed on paper.

According to claim 10 of the present invention, there is provided a billing system for use in a content distribution service based on one of claims 2 to 9, wherein the system further comprises distribution-result providing means for providing a distribution result made by the fee distribution means to the user.

In this system, the distribution-result providing means provides the distribution result made by the fee distribution means to the user.

The distribution-result providing means may be implemented in any fashion as long as the distribution-result providing means is capable of providing the distribution result made by the fee distribution means to the user. The distribution result may be provided in an active fashion to an user, for example, by displaying the distribution result made by the fee distribution means on a screen, or the distribution result may be provided in an inactive fashion to an user, for example, by providing it in response to an access by the user.

According to claim 11 of the present invention, there is provided a billing system for use in a content distribution service based on claim 10, wherein the system further comprises modify command input means for inputting a modify command to modify the distribution-manner information in response to the distribution result provided by the distribution-result providing means; and distribution information modifying means for modifying the distribution-manner information stored in the distribution-manner information storage means in accordance with the modify command inputted via the modify command input means.

In this system, when the distribution result is provided by the distribution-result providing means, if the user wants to modify the distribution-manner information in response to reception of the distribution result, the user inputs a modify command via the modify command input means. In response to the inputting of the modify command, the distribution information modifying means modifies the distribution-manner information stored in the distribution-manner information storage means in accordance with the modify command.

According to claim 12, in order to achieve the above-described object, there is provided a method of distributing a debt such that when additional information offered for being provided by an additional-information provider is transmitted to a user associated with a digital content, part or all of a debt imposed upon the user as a result of transmission of the digital content to the user is distributed to the additional-information provider, the method comprising the steps of: selecting a digital content and additional information from digital contents and additional information respectively stored in content storage means and additional-information storage means in accordance with a selection criterion, in terms of the debt distribution, designated by the user; and distributing part or all of the debt imposed upon the user to the additional-information provider in accordance with the selection results.

According to claim 13, in order to achieve the above-described object, there is provided a computer-readable storage medium in which is stored a debt distribution program for controlling a computer to execute a process of distributing a debt such that when additional information offered for being provided by an additional-information provider is transmitted to a user associated with a digital content, part or all of a debt imposed upon the user as a result of transmission of the digital content to the user is distributed to the additional-information provider, the process comprising the steps of: selecting a digital content and additional information from digital contents and additional information respectively stored in content storage means and additional-information storage means in accordance with a selection criterion, in terms of the debt distribution, designated by the user; and distributing part or all of the debt imposed upon the user to the additional-information provider in accordance with the selection results.

In this storage medium, the debt distribution program stored in the storage medium is read and executed by a computer so as to achieve functions and advantages similar to those of the debt distribution system in the content distribution service according to claim 1.

### BRIEF DESCRIPTION OF THE DRAWINGS

FIG. 1 is a block diagram illustrating a construction of a network system according to the present invention;

FIG. 2 is a block diagram illustrating a construction of a content distribution terminal 100;

FIG. 3 is a diagram illustrating a data structure of a user profile table 300;

FIG. 4(a) is a diagram illustrating layout definition files, and FIG. 4(b) is a diagram illustrating a data structure of a layout number correspondence table 340;

FIG. 5(a) is a diagram illustrating a digital content, and FIG. 5(b) is a diagram illustrating a data structure of a category number correspondence table 350;

FIG. 6 is a diagram illustrating a data structure of a content management table 360;

FIG. 7 is a diagram illustrating advertisement information and a data structure of an advertisement information management table 370;

FIG. 8 is a flow chart illustrating a user registration process;

FIG. 9 is a flow chart illustrating a content transmission process;

FIG. 10 is a diagram illustrating a screen for inputting a user ID and relating data;

FIG. 11 is a diagram illustrating a screen for designating a category;

FIG. 12 is a diagram illustrating a screen for inputting a destination address and relating data;

FIG. 13 is a diagram illustrating a screen for designating an output layout and relating data;

FIG. 14 is a diagram illustrating a screen for confirming contents to be registered;

FIG. 15 is a diagram illustrating a digital content; and

FIG. 16 is a diagram illustrating a screen for changing a maximum fee and a maximum advertisement fee.

### DETAILED DESCRIPTION OF PREFERRED EMBODIMENTS

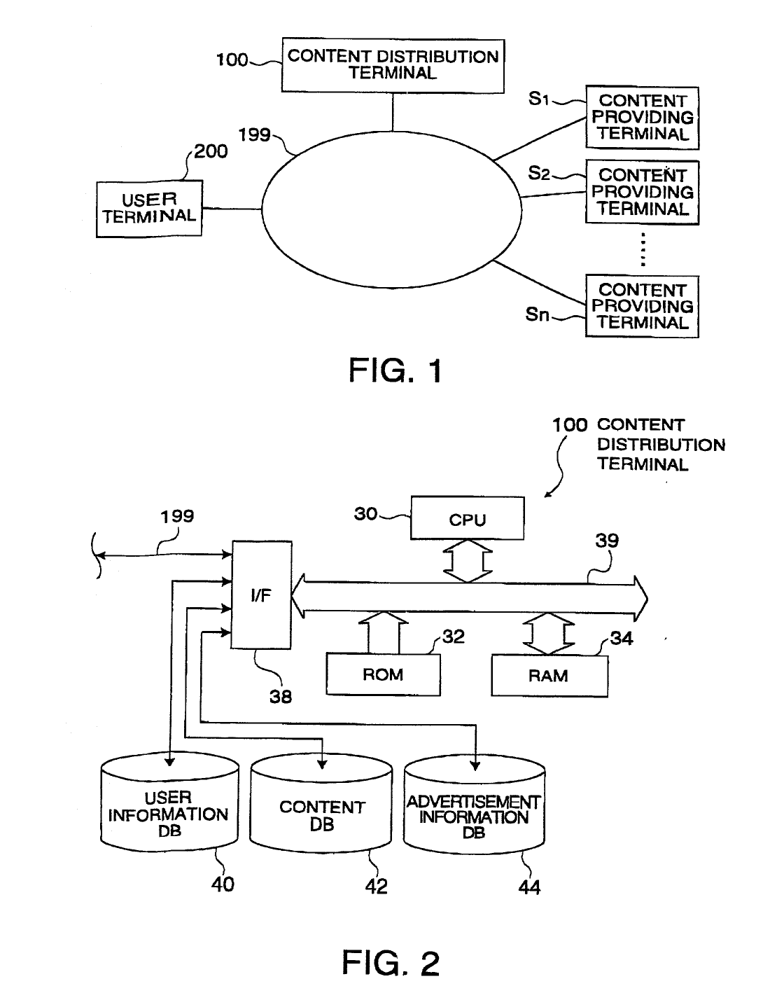

Embodiments of the present invention are described below with reference to the drawings. FIGS. 1 to 14 are diagrams illustrating a debt distribution system in a content distribution service, a billing system, a debt distribution method, and a storage medium, which embody the present invention.

In the present embodiment, in a content distribution service provided by a content distribution terminal 100, by way of example, the debt distribution system, the billing system, the debt distribution method, and the storage medium are installed in the content distribution terminal 100 as shown in FIG. 1 whereby advertisement information that an advertiser wants to provide is attached to a digital content concerning for example news, and the resultant digital content is transmitted to a user terminal 200.

Referring to FIG. 1, the construction of a network system used in the present invention is described below. FIG. 1 is a block diagram illustrating the construction of the network system used in the present invention.

As shown in FIG. 1, a plurality of content providing terminals S₁ to Sₙ for providing digital contents, the content distribution terminal 100 for transmitting digital contents that are stored therein after being provided from the content providing terminals S₁ to Sₙ, and the user terminal 200 used by a user are all connected to the Internet 199. Although only one user terminal 200 is displayed in FIG. 1 to facilitate the understanding of the present invention, a practical system includes a plurality of user terminals connected to the Internet 199.

Each of the content providing terminals S₁ to Sₙ is constructed so as to have functions similar to those of a computer of a usual type including a CPU, a ROM, a RAM, and an I/F connected to each other via a bus. When a digital content is produced, the digital content is transmitted to the content distribution terminal 100 together with a category number indicating a category of the digital content. The category number will be described later.

The user terminal 200 is also constructed so as to have functions similar to those of a computer of a usual type including a CPU, a ROM, a RAM, and an I/F connected to each other via a bus. The user terminal 200 includes a WWW browser that allows access to the content distribution terminal 100.

Referring to FIG. 2, the structure of the content distribution terminal 100 is described below. FIG. 2 is a block diagram illustrating the structure of the content distribution terminal 100.

As shown in FIG. 2, the content distribution terminal 100 includes a CPU 30 for performing a calculation and for controlling the whole system in accordance with a control program, a ROM 32 in which the control program or the like used by the CPU 30 is stored in a predetermined area thereof, a RAM 34 for storing data read from the ROM 32 or the like and for storing an intermediate result in a calculation performed by the CPU 30, and an I/F 38 via which data is output or input to or from an external device, wherein these elements are connected to each other via a bus 39 serving as a signal line so that data can be transmitted to each other via the bus 39.

The I/F 38 is connected to a user information database (hereinafter, a database is referred to as a DB) 40 for storing user information, a content DB 42 for storing digital contents provided by the content providing terminals S₁ to Sₙ, an advertisement information DB 44 for storing advertisement information to be provided together with a digital content to an user, and a signal line for connection with the Internet 199.

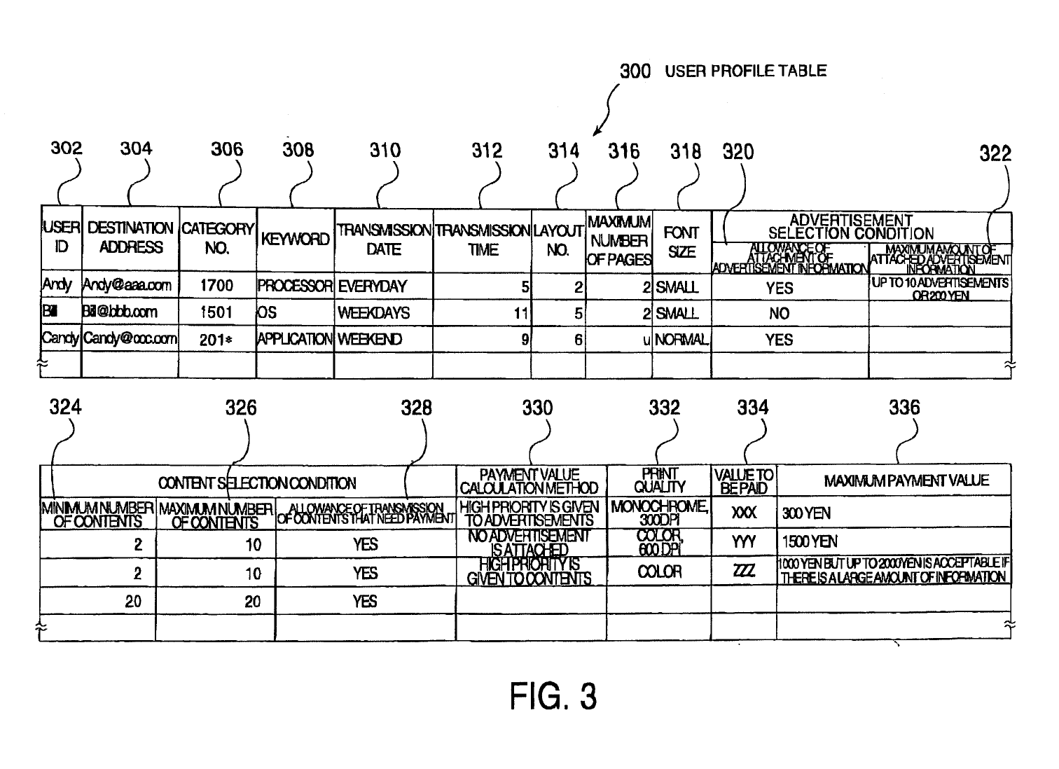

The user information DB 40 stores a user profile table 300 in which user information is described as shown in FIG. 3. FIG. 3 illustrates the data structure of the user profile table 300.

In the user profile table 300, as shown in FIG. 3, one or more records can be assigned to each user. Each record includes a field 302 for describing a user ID that identifies an user, a field 304 for describing an address to which a digital content is to be transmitted, a field 306 for describing a category number, a field 308 for describing a keyword, a field 310 for describing a transmission date, a field 312 for describing a transmission time, a field 314 for describing a layout number, a field 316 for describing a maximum number of pages, and a field 318 for describing a font size. Each record further includes a field 320 for describing an advertisement information selection condition indicating whether attachment of advertisement information is allowed, a field 322 for describing an advertisement information selection condition indicating the maximum number of advertisement information to be allowed, a field 324 for describing a digital content selection condition indicating the minimum number of digital contents to be included, a field 326 for describing a digital content selection condition indicating the maximum number of digital contents to be included, a field 328 for describing a digital content selection condition indicating whether attachment of a pay digital content is allowed, a field 330 for describing a payment value calculation method, a field 332 for describing print quality of a digital content, a field 334 for describing a payment value that should be actually paid by the user, and a field 336 for describing a maximum payment value.

In the field 308, a keyword is described which is used to retrieve digital contents including that keywords. A specific example of the keyword is a word that frequently appears in articles of a category in which the user is interested. In the example shown in FIG. 3, “processor” is described as the keyword in the first record, and “OS” is described in the second record.

The field 310 is used to describe a transmission date specified by a user as a date on which a digital content should be transmitted. More specifically, in the field 310, “everyday” may be described to specify that a digital content should be transmitted everyday, or “weekdays” to specify that a digital content should be transmitted only weekdays. In order to specify that a digital content should be transmitted only weekends, “weekends” is described in the filed 310. In the example shown in FIG. 3, “everyday” is specified in the first record, and “weekdays” is specified in the second record.

The field 312 is used to describe a transmission time of the transmission date specified by the user at which the digital content should be transmitted. More specifically, the transmission time may be described by a numeral from 0 to 23 expressed in a 24-hour clock. In the example shown in FIG. 3, “5” o'clock is specified in the first record, and “11” o'clock is specified in the second record.

The field 314 is used to describe a layout number indicating an output layout of a digital content. More specifically, a layout number indicating a layout desired by the user is described in this field. In the example shown in FIG. 3, “layout number 2” is specified in the first record, and “layout number 5” is specified in the second record. The layout number will be described in detail layer.

The field 316 is used to describe the maximum number of pages on which a digital content is displayed or printed. In this field, a value indicating the maximum number of pages may be described or a character “u” may be described to indicate that the upper limit of the number of pages is undefined. In the example shown in FIG. 3, “2 pages” is specified in the first record, and “u” is described in the third record.

The field 318 is used to describe a font size that should be used when a digital content is displayed or printed. In the example shown in FIG. 3, a “small” size is specified in the first record, and a “normal” size is specified in the third record.

The field 320 is used to describe whether to attach advertisement information with a digital content. In the example shown in FIG. 3, “yes” is described in the first record to indicate that attachment of advertisement information with a digital content is allowed. On the other hand, “no” is described in the second record to indicate that no advertisement information should be attached with a digital content.

The field 322 is used to describe the maximum number of advertisements that are allowed to be attached with a digital content in the case where attachment of advertisement information is allowed. In the example shown in FIG. 3, “up to 10 advertisements or 200 yen” is described in the first record to specify that attachment of advertisement information is allowed if the number of attached advertisements is equal to or less than 10 or the discount value resulting from the attachment of advertisement information is equal to or less than 200 yen.

The field 324 is used to describe a value indicating the minimum number of digital contents to be included when they are produced. In the example shown in FIG. 3, “2” is described in this field of the first record to specify that two or more digital contents should be transmitted at a time.

The field 326 is used to describe a value indicating the maximum number of digital contents to be included when they are produced. In the example shown in FIG. 3, “10” is described in the first record to specify that up to 10 digital contents should be transmitted at a time.

The field 328 is used to describe whether transmission of a digital content that needs payment is allowed. In the example shown in FIG. 3, “yes” is described in the first record to specify that transmission of a digital content that needs payment is allowed.

The field 330 is used to describe a payment value calculation method. In the example shown in FIG. 3, “high priority to advertisement” is described in the first record to specify that when both advertisement selection condition and digital content selection condition cannot be satisfied at the same time, the advertisement selection condition should be prioritized over the digital content selection condition. On the other hand, “high priority to content” is described in the third record to specify that when both advertisement selection condition and digital content selection condition cannot be satisfied at the same time, the digital content selection condition should be prioritized over the advertisement selection condition.

The field 336 is used to describe a value indicating the maximum payment value to be paid by the user. In the example shown in FIG. 3, “1000 in the normal situation and 2000 yen when there is a large amount of information” is described in the third record to specify that digital contents and advertisement information should be selected in the normal situation such that the payment value becomes equal to or less than 1000 yen but up to 2000 yen of payment is exceptionally accepted if there are a large number of digital contents that meet the selection condition.

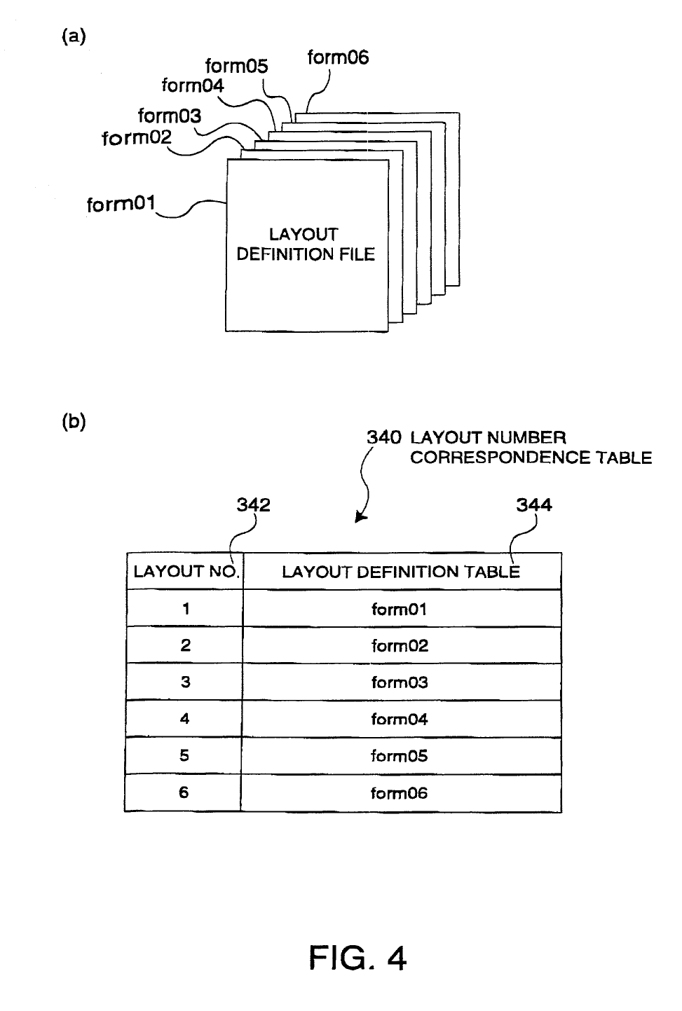

The user information DB 40 includes, as shown in FIG. 4, a plurality of layout definition files denoted by form 01 to form 06 in which digital content output layouts are defined and also includes a layout number correspondence table 340 indicating the correspondence between the layout definition files (form 01 to form 06) and the layout numbers. FIG. 4 is a diagram illustrating layout definition files and also illustrating the data structure of the layout number correspondence table 340.

In the layout number correspondence table 340, as shown in FIG. 4(b), one record is assigned to each layout number. Each record includes a field 342 for describing a layout number and a field 344 for describing a file name of a layout definition file. In the example shown in FIG. 4(b), “1” is described as the layout number and “form 01” is described as the layout definition file name in the first record, and “2” and “form 02” are described as the layout number and the layout definition file name in the second record.

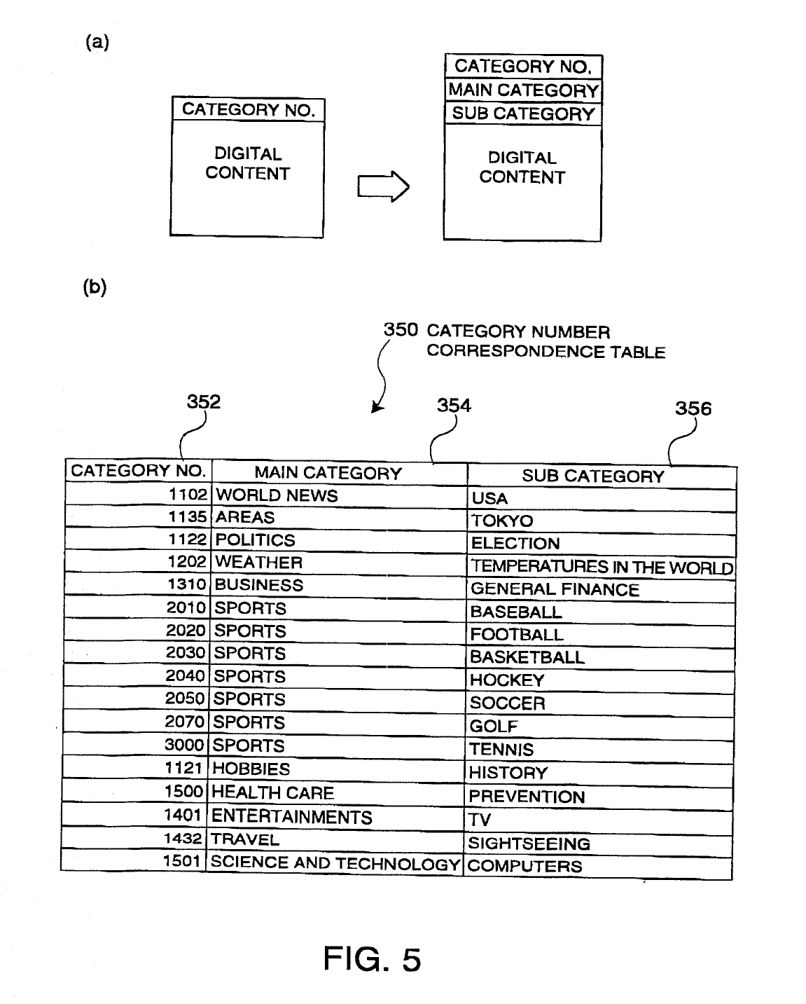

As shown in FIG. 5, the content DB 42 includes a category correspondence table 350 indicating the correspondence among digital contents provided by the content providing terminals S₁ to Sₙ, main categories, sub-categories, and category numbers. FIG. 5 is a diagram illustrating data structures of the digital content and the category number correspondence table 350.

As shown in FIG. 5(a), each digital content provided by the content providing terminals S₁ to Sₙ includes data indicating its category number. The content distribution terminal 100 categories the digital contents in accordance with the assigned category numbers and registers them in the content DB 42. When a digital content is registered, the category number correspondence table 350 is accessed to determine the main category and the sub-category of the digital content, and the digital content is registered together with the main category and the sub categories as well as the category number.

In the category number correspondence table 350, as shown in FIG. 5(b), one record is assigned to each combination of a main category and a sub category. Each record includes a field 352 for describing a category number, a field 354 for describing a main category, and a field 356 for describing a sub category. In the example shown in FIG. 5(b), the first record is described such that “1102” is stored as the category number, “world news” as the main category, and “USA” as the sub category. On the other hand, in the sixth record, “2010” is stored as the category number, “sports” as the main category, and “baseball” as the subcategory.

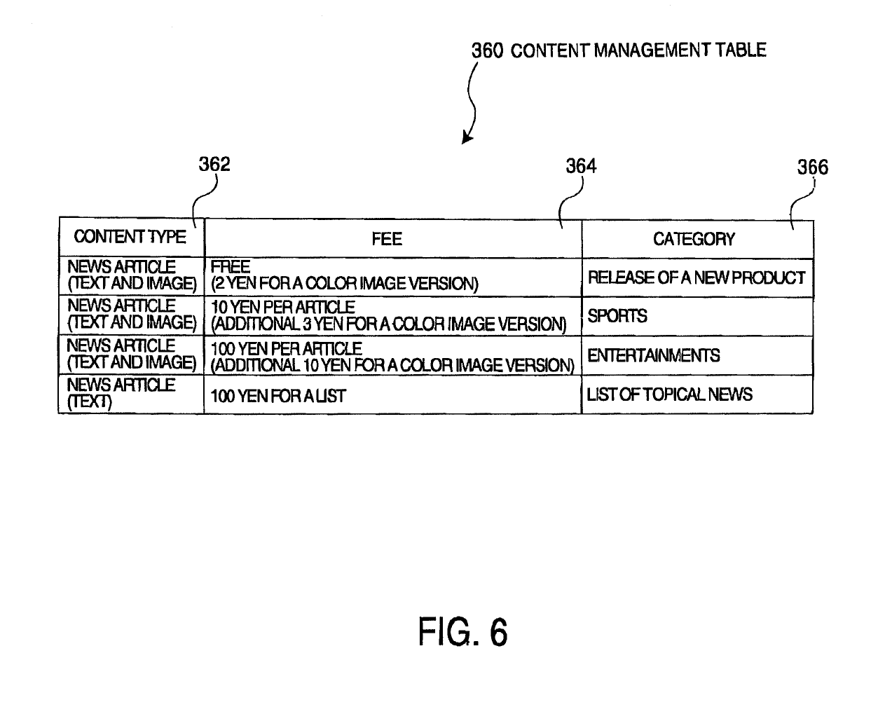

The content DB 42 stores, as shown in FIG. 6, a content management table 360 in which categories of digital contents and fees for respective digital contents are described. FIG. 6 is a diagram illustrating the data structure of the content management table 360.

In the content management table 360, as shown in FIG. 6, one record is assigned to each digital content. Each record includes a field 362 for describing the file name and the type of the digital content, a field 364 for describing the fee that should be paid by a user to read the digital content, and a field 366 for describing the category of the digital content. In the examples shown in FIG. 6, the second record is described such that “news articles (text and image)” is stored as the type of the digital content, “10 yen per article (additional 3 yen for a color image version)” is stored as the fee, and “sports” is stored as the category. That is, the second record indicates that the digital content is of a news article about a sport including text and image data, ten yen is required as the fee for the monochrome image version and 13 yen for the color image version.

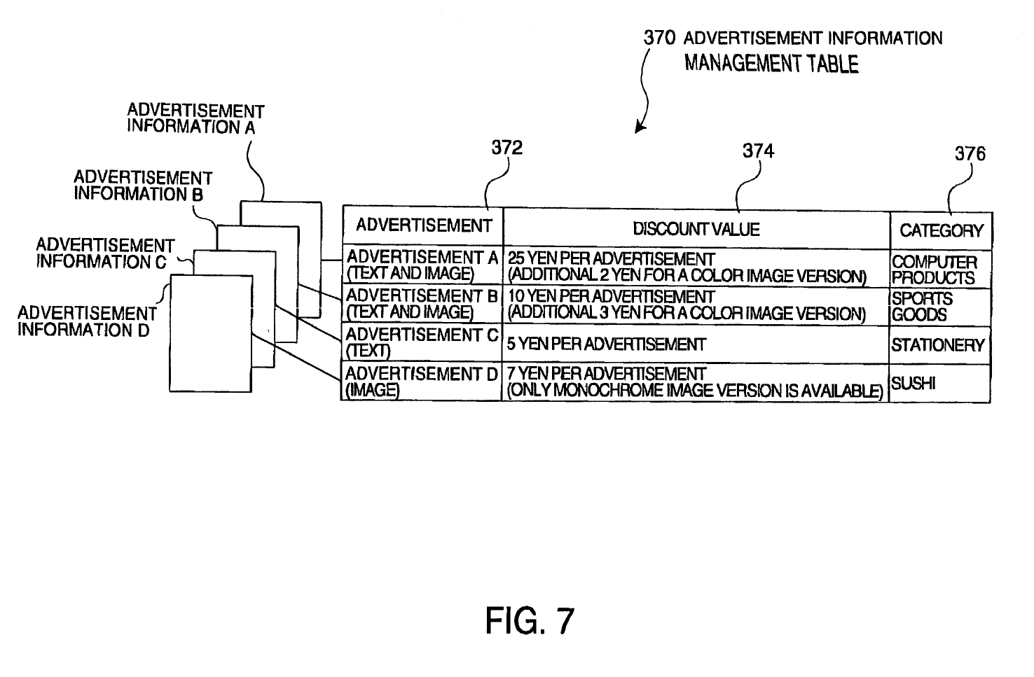

The advertisement information DB 44 stores, as shown in FIG. 7, an advertisement information management table 370 in which plural pieces of advertisement information A to D, the categories of the respective advertisement information, and the discount values corresponding to the respective advertisement information are described. FIG. 7 is a diagram illustrating advertisement information and the data structure of the advertisement information management table 370.

In the advertisement information management table 370, as shown in FIG. 7, one record is assigned to each advertisement information A to D. Each record includes a field 372 for describing the file name of advertisement information and the type thereof, a field 374 for describing the amount that is to be reduced, when the advertisement information is attached, from the fee paid by an user, and a field 376 for describing the category of the advertisement information. In the example shown in FIG. 7, the second record is described such that “advertisement B (text and image)” is stored as the type of the advertisement information, “10 yen per advertisement (additional 3 yen for a color image version)” is stored as the discount amount, and “sports goods” is stored as the category. That is, this record indicates that the advertisement information B is an advertisement of sports goods including text and image data, and 10 yes is discounted for each attachment of the monochrome version of the advertisement information B and 13 yen for the color image version. For example, in the case where the advertisement information B is attached to the digital content registered in the second record of the content management table 360, if both the digital content and the advertisement information are of the color image version, then the fee for the digital content is 13 yen and the discount amount is 13 yen, and thus the amount to be paid by a user becomes 0 yen because the fee for the digital content is cancelled by the discount amount.

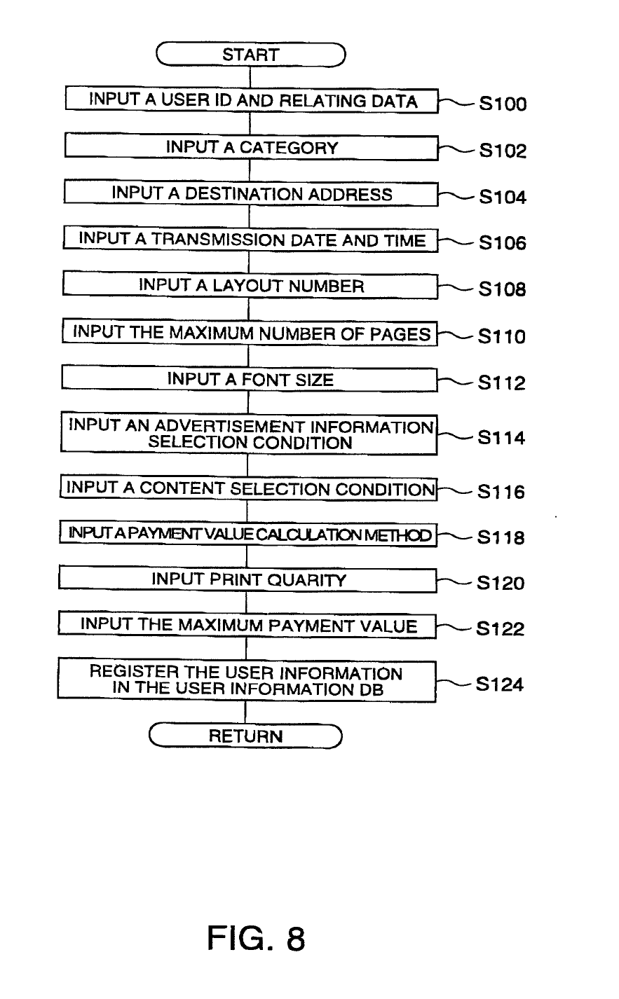

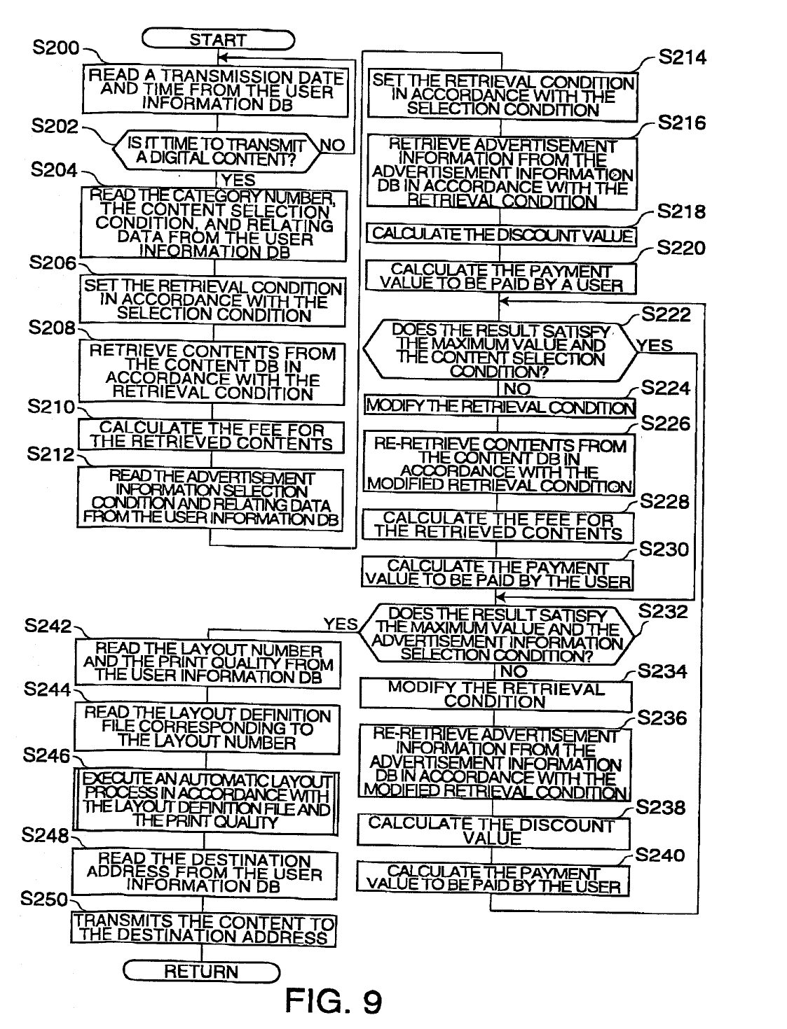

The structure of the CPU 30 and a process performed by the CPU 30 are described below with reference to FIGS. 8 and 9.

The CPU 30 is constructed of a microprocessing unit MPU or the like and serves to execute the user registration process and the content distribution process shown respectively in the flow charts of FIGS. 8 and 9 on a time division basis in accordance with a program stored in a predetermined storage area of the ROM 32.

First, a user registration process is described below with reference to FIG. 8. FIG. 8 is a flow chart illustrating the user registration process.

In the user registration process, when an access is made by an user, the process requests the user to input necessary user information such as a user ID, and registers the inputted user information in the user profile table 300. If the user registration process is started by the CPU 30, step S100 is first executed as shown in FIG. 8. Each step in the user registration process is performed via interactive communication with the user.

In step S100, a user ID and a password are inputted. In step S102, a main category and a sub category are inputted. In step S104, an address to which a digital content is to be transmitted is inputted. In step S106, transmission date and transmission time are inputted. Thereafter, the process proceeds to step S108.

In step S108, a layout number is inputted. In step S110, the maximum number of pages is inputted. In step S112, a font size is inputted. Thereafter, the process proceeds to step S114.

In step S114, as an advertisement information selection condition, data is inputted to specify whether attachment of advertisement information is allowed and to specify how many advertisements are, at most, allowed to be attached. In step S116, digital content selection conditions are inputted in terms of the minimum number of digital contents, the maximum number of digital contents, and as to whether transmission of a digital content that needs payment is allowed. Thereafter, the process proceeds to step S118.

In step S118, a payment value calculation method is inputted. In step S120, a print quality is inputted. In step S122, the maximum value of the fee is inputted. In step S124, user information inputted in steps S100 to S122 is stored in the user profile table 300. After completion of step S124, the user registration process is ended and the process returns to the original process.

Now, the content distribution process is described in detail with reference to FIG. 9. FIG. 9 is a flow chart illustrating the content distribution process.

In the content distribution process, with reference to the user profile table 300, a digital content is transmitted to a user terminal 200. When the content distribution process is started by the CPU 30, step S200 is first executed as shown in FIG. 9. Although, in the following description, the process is performed only for one record of the user profile table 300, in a practical operation, each step is performed as many times as there are records registered in the user profile table 300.

In step S200, a transmission date and a transmission time are read from the user profile table 300. In step S202, it is determined, on the base of the read transmission date and transmission time, whether a digital content should be transmitted now. If it is determined that the digital content should be transmitted now (if the answer is “yes”), the process proceeds to step S204. However, if it is determined that the digital content should not be transmitted now (if the answer is “no”), the process proceeds to step S200.

In step S204, a category number, a digital content selection condition, and a payment value calculation method are read from the user profile table 300. In step S206, the digital content retrieval condition is set in accordance with the read category number, digital content selection condition, and payment value calculation method. In step S208, the content DB 42 is searched in accordance with the retrieval condition set above to retrieve a digital content that meets the retrieval condition. In step S210, with reference to the content management table 360, the sum of fees for the retrieved digital contents is calculated. Thereafter, the process proceeds to step S212.

In step S212, an advertisement information selection condition and a payment value calculation method are read from the user profile table 300. In step S214, the advertisement information retrieval condition is set in accordance with the read advertisement information selection condition and payment value calculation method. In step S216, the advertisement information DB 44 is searched in accordance with the retrieval condition set above to retrieve advertisement information that meets the retrieval condition. In step S218, with reference to the advertisement information management table 370, the sum of discount values for the retrieved advertisement information is calculated. Thereafter, the process proceeds to step S220.

In step S220, the fee to be paid by a user is determined by subtracting the total discount value calculated in step S218 from the total fee calculated in step S210. Thereafter, the process proceeds to step S222.

In step S222, the maximum value of the fee is read from the user profile table 300, and it is determined whether the retrieval result in terms of the digital content meets the digital content selection condition and it is also determined whether the calculated fee to be paid by the user is equal to or less than the maximum value. If it is determined that the retrieval result does not meet the digital content selection condition or it is determined that the calculated value to be paid is greater than the maximum value (if the answer is “no”), the process proceeds to step S224.

In step S224, the retrieval condition is modified so that the retrieval result will meet the digital content selection condition and so that the value to be paid by the user will be equal to or less than the maximum value. In step S226, the content DB 42 is searched again in accordance with the modified retrieval condition to retrieve a digital content that meets the modified retrieval condition. In step S228, with reference to the content management table 360, the sum of fees for the retrieved digital contents is calculated. In step S230, the value to be paid by the user is determined by subtracting the discount value that has been already calculated from the calculated sum of fees. Thereafter, the process proceeds to step S232.

In step S232, the maximum value of the fee is read from the user profile table 300, and it is determined whether the retrieval result in terms of the advertisement information meets the advertisement information selection condition and it is also determined whether the calculated value to be paid by the user is equal to or less than the maximum value. If it is determined that the retrieval result does not meet the advertisement information selection condition or it is determined that the calculated value to be paid is greater than the maximum value (if the answer is “no”), the process proceeds to step S234.

In step S234, the retrieval condition is modified so that the retrieval result will meet the advertisement information selection condition and so that the value to be paid by the user will be equal to or less than the maximum value. In step S236, the advertisement information DB 44 is searched again in accordance with the modified retrieval condition to retrieve advertisement information that meets the modified retrieval condition. In step S238, with reference to the advertisement information management table 370, the sum of discount values for the retrieved advertisement information is calculated. In step S240, the value to be paid by the user is determined by subtracting the calculated total discount value from the total fee that has already been calculated. Thereafter, the process proceeds to step S222.

In the case where it is determined in step S232 that the retrieval result in terms of the advertisement information meets the advertisement information selection condition and the calculated value to be paid by the user is not greater than the maximum value (if the answer in step S232 is “yes”), the process proceeds to step S242.

In step S242, a layout number and print quality are read from the user profile table 300. In step S244, with reference to the layout number correspondence table 340, a layout definition file corresponding to the read layout number is read from the user information DB 40. In step S246, in accordance with the read layout definition file and in accordance with the specified print quality, the digital contents and advertisement information, which have been retrieved in steps S208, S216, S226, and S236, are subjected to a layout processing in which an output layout is automatically determined and executed. Thereafter, the process proceeds to step S248.

In step S248, a destination address is read from the use profile table 300. In step S250, the digital content is transmitted to the read destination address. Thereafter, the content distribution process is ended and the process returns to the main process.

In the case where it is determined in step S222 that the retrieval result in terms of the digital content meets the digital content selection condition and the calculated value to be paid by the user is not greater than the maximum value (if the answer in step S222 is “yes”), the process proceeds to step S232.

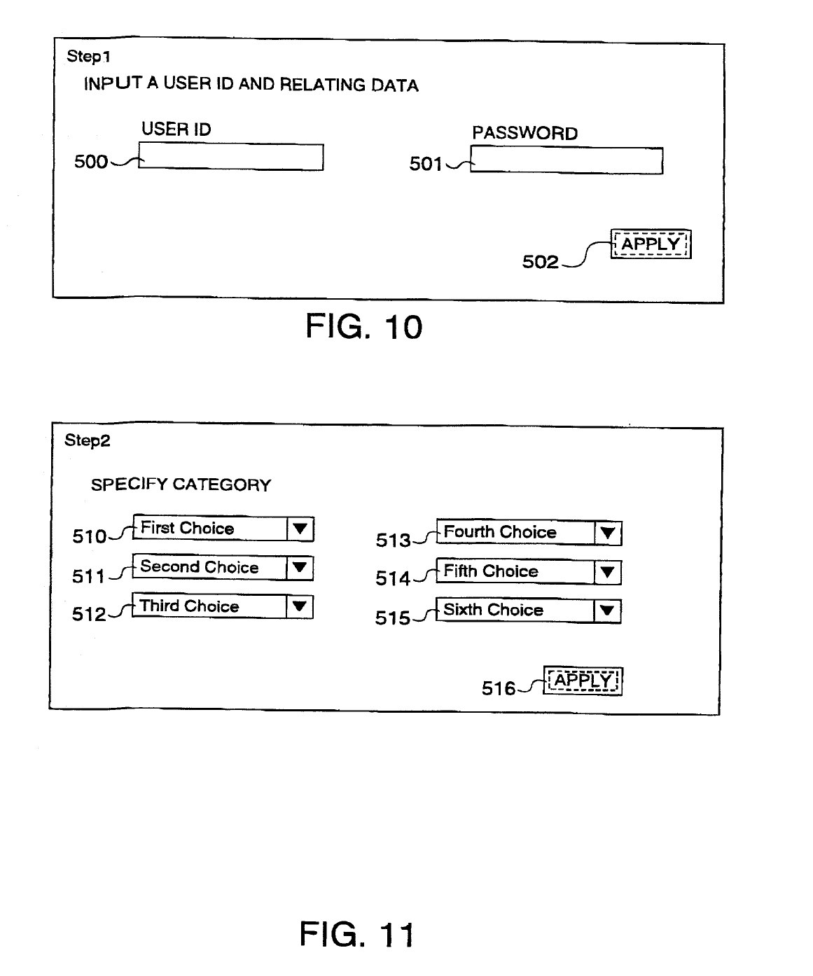

The operation of the present embodiment is described below with reference to FIGS. 10 to 14.

First, the operation of registering information necessary in transmission of digital contents is described.

When a user wants to acquire a digital content, the user at the user terminal 200 accesses the content distribution terminal 100 via a WWW browser and inputs a user registration request.

After inputting the user registration request, the user terminal 200 communicates with the content distribution terminal 100 to receive screen data for representing a screen used to input a user ID and other data. In accordance with the received screen data, a screen is displayed as shown in FIG. 10. FIG. 10 is a diagram illustrating the screen for inputting user ID and other data.

The user inputs user ID and a password via the screen shown in FIG. 10. More specifically, for example, the user ID and the password are inputted by operating a keyboard or the like so as to input numeral values or characters into text boxes 500 and 501. After inputting the user ID and the password, an “Apply” button 502 is clicked.

After completion of inputting of the user ID and the password, the user terminal 200 transmits the user ID and the password to the content distribution terminal 100. Thereafter, the user terminal 200 communicates with the content distribution terminal 100 to receive screen data for representing a category designation screen used to designate a category of a digital content. In accordance with the received screen data, a screen is displayed as shown in FIG. 11. FIG. 11 is a diagram illustrating the screen for designating the category.

Herein, as shown in FIG. 11, the user can designate up to six categories of digital contents the user wants to acquire. The designation of categories may be performed, for example, by selecting a desired category from a list provided in each of combo boxes 510 to 515. After completion of inputting the categories, an “Apply” button 516 is clicked.

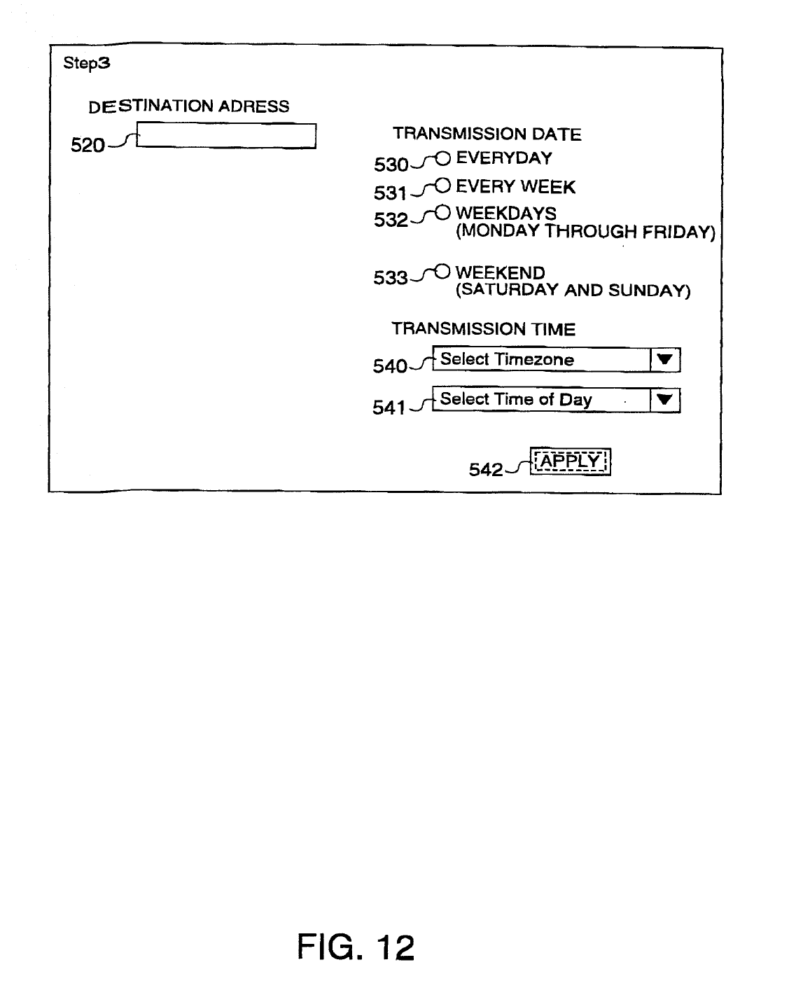

Upon completion of designating the categories, the user terminal 200 transmits data indicating the designated categories to the content distribution terminal 100. The user terminal 200 then communicates with the content distribution terminal 100 to receive screen data for representing a screen used to input a destination address to which digital content should be transmitted and other data. In accordance with the received screen data, a screen is displayed as shown in FIG. 12. FIG. 12 is a diagram illustrating the screen for inputting the destination address to which digital contents should be transmitted and others.

Herein, as shown in FIG. 12, the user inputs a destination address to which digital contents should be transmitted and also inputs desired transmission date and time at which digital contents should be transmitted. More specifically, for example, the destination address is inputted by operating the keyboard or the like so as to input numeral values or characters into a text box 520. The transmission date may be designated by selecting one of option buttons 530 to 533 indicating, for example, “everyday”, “every week”, “weekdays (Monday through Friday)”, and “weekends (Saturday and Sunday)”. The transmission time may be designated by selecting one of values listed in each of combo boxes 540 and 541. After completion of inputting the above data, an “Apply” button 542 is clicked.

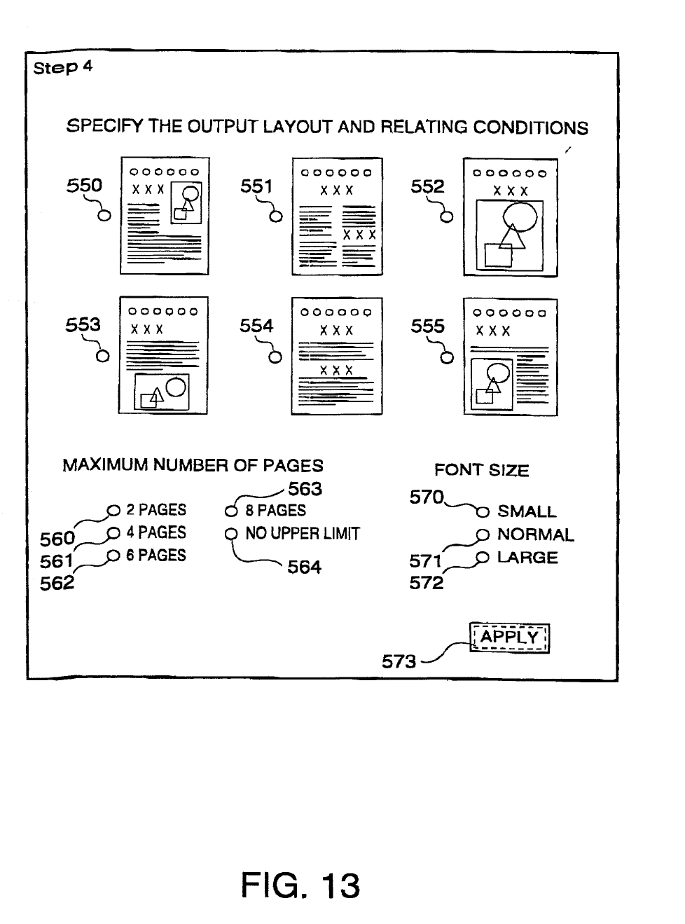

Upon completion of inputting the destination address and other data, the user terminal 200 transmits data indicating the destination address and other data to the content distribution terminal 100. The user terminal 200 then communicates with the content distribution terminal 100 to receive a screen data representing a screen used to designate an output layout of a digital content and other relating data. In accordance with the received screen data, a screen is displayed as shown in FIG. 13. FIG. 13 is a diagram illustrating the screen for designating the output layout and others.

Herein, as shown in FIG. 13, the user specifies a layout number, the maximum number of pages, and a font size. The layout number may be specified, for example, by selecting one of six option buttons 550 to 555 corresponding to respective sample images indicating layouts. The maximum number of pages may be specified, for example, by selecting one of option buttons 560 to 564 corresponding to “2 pages”, “4 pages”, “6 pages”, “8 pages”, and “no upper limit”. The font size may be specified, for example, by selecting one of option buttons 570 to 572 corresponding to “small”, “normal”, and “large”. After completion of the above designation, an “Apply” button 573 is clicked.

After completion of designating the output layout and relating conditions, the user terminal 200 transmits data indicating the designated output layout and the relating conditions to the content distribution terminal 100. Thereafter, although not shown in the figure, the user terminal 200 communicates with the content distribution terminal 100 and displays various screens for inputting an advertisement information selection condition, a digital content selection condition, a payment value calculation method, print quality, and a maximum payment value.

Herein, in a similar manner as described above with reference to FIGS. 10 to 13, the user inputs an advertisement selection condition, a digital content selection condition, a payment value calculation method, print quality and a maximum payment value. The advertisement information selection condition, the digital content selection condition, and the payment value calculation method may be inputted, for example, by selecting one of conditions or values listed in menus provided in combo boxes. After completion of inputting above conditions or values, an “Apply” button is clicked.

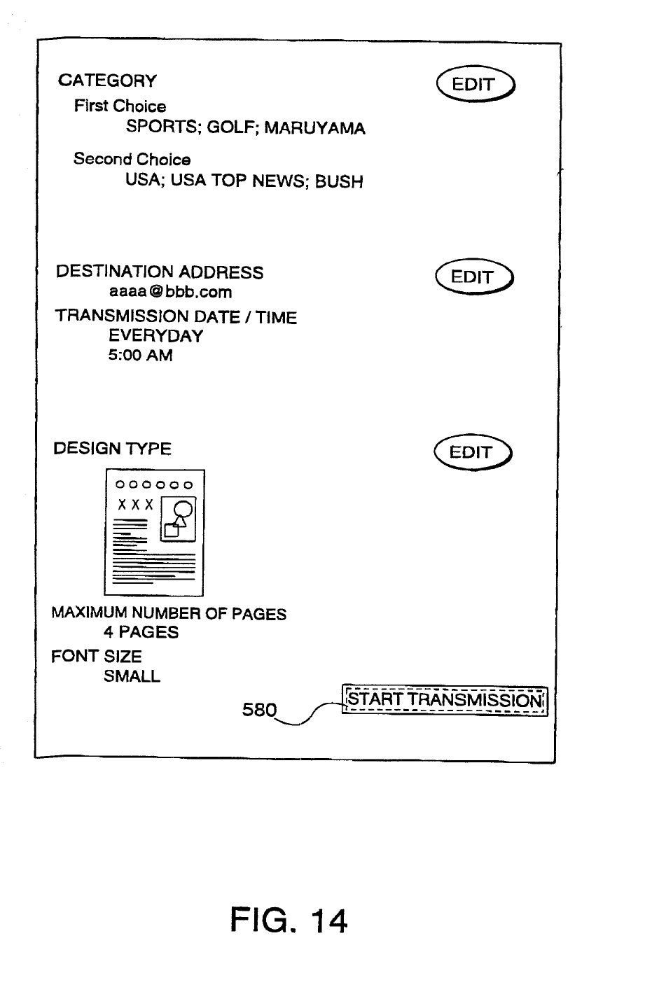

Thereafter, the user terminal 200 transmits data indicating the conditions such as the advertisement selection condition to the content distribution terminal 100. The user terminal 200 then communicates with the content distribution terminal 100 to receive screen data representing a screen for confirming the contents to be registered. In accordance with the received screen data, a screen is displayed as shown in FIG. 14. FIG. 14 is a diagram illustrating the screen for confirming the contents to be registered.

In the example shown in FIG. 14, “sports, golf, Maruyama” and “USA, top news of the USA, Bush” are specified as the categories, “aaa@bbb.com” is specified as the destination address, and “everyday” and “5:00 am” are specified as the transmission date and time. Furthermore, a sample image indicating the selected output layout is displayed, and “4 pages” is specified as the maximum number of pages, and “small” is specified as the font size. If the contents to be registered are correct, the user clicks a “Start Transmission” button 580.

In response to completion of confirming the contents to be registered, the user terminal 200 transmits a transmission start request to the “content distribution terminal 100.

Upon receiving the transmission start request, the content distribution terminal 100 registers, in step S124, the user information such as the user ID received via the above steps into the user profile table 300.

Now, the process of transmitting a digital content with reference to the user profile table 300 is described below.

In steps S204 and S206, with reference to the user profile table 300, when the specified digital content transmission data/time has been reached, the content distribution terminal 100 reads the category number, the digital content selection condition, and the payment value calculation method from the user profile table 300. On the basis of the read category number, digital content selection condition, and fee calculation method, the digital content retrieval condition is set. Thereafter, in step S208, the content DB 42 is searched in accordance with the retrieval condition to retrieve a digital content that meets the retrieval condition. In step S210, the total fee for the retrieved digital contents is determined by calculating the sum of the fees for respective digital contents.

In steps S212 and S214, the advertisement selection condition and the payment value calculation method are read from the user profile table 300. On the basis of the read advertisement selection condition and payment value calculation method, the advertisement information retrieval condition is set. In step S216, the advertisement information DB 44 is searched in accordance with the retrieval condition to retrieve advertisement information that meets the retrieval condition. In steps S218 and S220, the total discount value is determined by calculating the sum of discount values associated with the respective retrieved advertisement information. The value to be paid by the user is then determined by subtracting the total discount value from the total fee.

In the retrieval of advertisement information, in the case where the user is interested in a category of computer and the maximum discount value is set to 200 yen, advertisement information is selected from advertisement information of computers so that the discount value does not exceed 200 yen. On the other hand, in the case where the maximum payment value is set to 300 yen although the maximum discount value is not specified, if the total fee for the retrieved digital contents is, for example, 400 yen, advertisement information is selected so that the total discount value becomes equal to or greater than 100 yen thereby ensuring that the payment value becomes equal to or less than 300 yen.

In the present example, the advertisement information retrieval is performed after the digital content retrieval. Alternatively, the retrieval may be performed in the opposite order in a similar manner. That is, digital contents may be selected in accordance with the discount value and the maximum payment value so that the payment value does not exceed the maximum payment value.

However, in this case, there is a possibility that a digital content that meets the digital content selection condition specified by a user is not selected because of the restriction in terms of the payment value. To avoid the above problem, it is preferable that the digital content retrieval be performed before the advertisement information retrieval. If the advertisement information retrieval is performed before the digital content retrieval, it is preferable to re-perform the advertisement information to avoid the above problem.

In the case where the result of the digital content retrieval does not meet the digital content selection condition or the payment value is greater than the maximum payment value, the digital content retrieval condition is modified in step S224 and the content DB 42 is re-searched, in step S226, in accordance with the modified retrieval condition to retrieve a digital content that meets the modified retrieval condition. In step S228, the total fee for the retrieved digital contents is determined by calculating the sum of the fees for respective retrieve digital contents, and then, in step S230, the value to be paid by the user is determined by subtracting the discount value that has been already calculated from the total fee.

In the case where the result of the advertisement information retrieval does not meet the advertisement information selection condition or the payment value is greater than the maximum payment value, the advertisement information retrieval condition is modified in step S234, and then in step S236, the advertisement information DB 44 is re-searched in accordance with the modified retrieval condition to retrieve advertisement information that meets the modified retrieval condition. Thereafter, in step S238, the total discount value is determined by calculating the sum of the discount values for respective advertisement information, and furthermore, in step S240, the value to be paid by the user is determined by subtracting the total discount value from the total fee that has been already calculated.

As described above, when the retrieval result does not meet the desire of the user as is the case in which the payment value is greater than the maximum value, the retrieval condition is modified and the retrieval is re-performed in accordance with the modified retrieval condition. The re-retrieval is performed repeatedly until the result of the digital content retrieval satisfies the digital content selection condition and the payment value becomes equal to or smaller than the maximum payment value, and furthermore until the result of the advertisement information retrieval satisfies the advertisement information selection condition and the payment value becomes equal to or smaller than the maximum payment value.

On the other hand, in a series of retrievals described above, in the case where the result of the digital content retrieval meets the digital content selection condition, the payment value is not greater than the maximum value, the result of the advertisement information retrieval meets the advertisement information selection condition, and the payment value is not greater than the maximum payment value, the layout number and print quality are read, in step S242, from the user profile table 300, and then, in step S244, the layout definition file corresponding to the read layout number is read from the user information DB 40. Thereafter, in step S246, the digital contents and the advertisement information retrieved in the previous steps are laid out in accordance with the read layout definition file and the print quality.

In step S248, the destination address is read from the user profile table 300, and then, in step S250, the resultant digital content data is transmitted to the destination address.

The calculated payment value is cumulatively added to the value described in the field 334 of the user profiled table 300. On a predetermined day of every month, the cumulative payment value is read from the field 334 and a bill is sent to the user. After sending the bill, the value in the field 334 is cleared.

In the present embodiment, as described above, in the retrieval of the digital contents, the digital contents are selected such that the total fees for the digital contents to be selected does not become greater than the sum of the maximum value indicated by the user profile table 300 and the total discount value associated with the selected advertisement information, and in the retrieval of the advertisement information, the advertisement information is selected such that the total fees for the selected digital contents does not become greater than the sum of the maximum value indicated by the user profile table 300 and the total discount value associated with the additional information to be selected.

Thus, the user can receive digital contents without resulting in payment exceeding the maximum value specified by the user thereby making it possible to prevent the user from being charged an unexpectedly high fee even in a content distribution service in which the fee is charged depending upon the amount of information provided. When digital contents that meet the desire of the user are all selected, if the total fee exceeds the maximum payment value specified by the user, advertisement information is attached to the digital contents so that the excess amount of the fee is cancelled by the discount value resulting from the attachment of the advertisement information, thereby eliminating the problem that digital contents desired by the user are not provided to the user because of the limitation in terms of payment. Furthermore, it becomes possible to adjust the method of charging the fee and the digital content selection condition in accordance with the desire of the user, and thus the desire of the user can be satisfied to some extent even in the content distribution service in which the fee is charged depending upon the amount of information provided.

Thus, unlike the conventional technologies, the system according to the present embodiment can provide digital contents to individual users in accordance with the methods of charging the fee and the digital content selection conditions specified by the respective users without causing an unexpectedly high fees to be charged to the users.

Furthermore, in the present embodiment, the content distribution terminal 100 has the user information DB 40 in which a plurality of layout definition files are stored, the content distribution terminal 100 lays out the digital contents in accordance with the definition described in the specified layout definition file stored in the user information DB 40 and the content distribution terminal 100 transmits the laid-out digital contents.

This makes it possible to output digital contents laid out in accordance with the desire of the user so that the user can view the digital contents laid out in the manner specified by the user.

Furthermore, in the present embodiment, the content distribution terminal 100 has the content DB 42 in which a plurality of digital contents are stored. The content distribution terminal 100 reads content numbers and a layout definition file corresponding to the content numbers from the user information DB 40, selects digital contents from the content DB 42 in accordance with the read content numbers, determines the output layout for the selected digital contents in accordance with the layout definition file, and lays out the digital contents.

Thus, only digital contents that meet the desire of the user are laid out, and the resultant data includes no digital contents that do not meet the user's preference. Thus, the resultant digital contents are outputted after being laid out in a fashion desirable for the user to view.

Furthermore, in the present embodiment, the content distribution terminal 100 transmits digital contents at the transmission time on the transmission date specified by the user profile table 300.

Thus, the invention can provide a digital content distribution service that can satisfy the user's desire that digital contents should be delivered at the particular time on the particular date specified by the user.

In the embodiments described above, the advertiser corresponding to the additional-information provider described in claims 1, 2, 12, and 13, the payment value to be paid by the user corresponds to the debt imposed on a user described in claims 1, 12 and 13, the advertisement information corresponds to the additional information described in claims 1 to 9, 12 and 13. The data in the field 364 corresponds to the digital-content-fee information described in claims 3 to 8, the data in the field 374 corresponds to the discount value information described in claims 3 to 8, and the user information in the fields 320 to 328 and 336 corresponds to the distribution-manner information described in claims 2 to 8 or 11.

The content DB 42 corresponds to the content storage means described in claims 1, 2, 3, 12, and 13, the advertisement information DB 44 corresponds to the additional-information storage means described in claims 1, 2, 3, 12, and 13, and the user information DB 40 corresponds to the distribution-manner information storage means described in claims 2, 3, and 11 or to the user information storage means described in claim 9. Steps S206, S208, S222 to S226 correspond to the content selection means described in claims 2 to 8, steps S214, S216, S232 to S236 correspond to the additional-information selection means described in claims 2 to 8, step S246 corresponds to additional-information linkage means described in claim 2, and step S250 corresponds to the content distribution means described in claims 2 and 9.

Furthermore, steps S220, S230, and S240 correspond to the fee distribution means described in claims 2, 7, 8, and 10, steps S210 and S228 correspond to the fee calculation means described in claim 6, steps S218 and S238 correspond to the discount value calculation means described in claim 6, and step S246 corresponds to the content layout means described in claim 9.

In the embodiments described above, when the result of the digital content retrieval does not meet the digital content selection condition, or when the fee therefor is greater than the specified maximum value, the digital content retrieval condition is modified and the retrieval is re-performed in accordance with the modified retrieval condition. However, in the present invention, it may not be necessarily required to re-perform the retrieval of digital contents. That is, steps S222 to S230 may not be necessarily provided.

Furthermore, in the embodiments described above, when the result of the advertisement information retrieval does not meet the advertisement information selection condition, or when the resultant fee to be paid by the user is greater than the specified maximum value, the advertisement information retrieval condition is modified and the retrieval is re-performed in accordance with the modified retrieval condition. However, in the present invention, it may not be necessarily required to re-perform the retrieval of advertisement information. That is, steps S232 to S240 may not be necessarily provided.

Furthermore, in the embodiments described above, the discount value varies depending upon the number of attached advertisement information. Alternatively, the discount value may be varied depending upon the area per page in which the advertisement information is placed, or depending upon the image quality in the case where the advertisement information includes image information.

In the above embodiments, a process has not been described which is to be performed when the subtraction of the discount value from the fee results in a negative value. In this case, the negative value may be carried as a discount value into the next month or the negative may be relinquished. Alternatively, another benefit may be offered to the user.

In another embodiment, the user profile table 300 may store information indicating whether a digital content provided to a user in the past was printed by the user, and the discount value may be determined depending upon the print history. In the case where printing was performed, information indicating the print quality may also be described in the user profile table 300 so that the discount value may be determined taking into account the print quality. For example, in the case where a digital content provided in the past was printed, the fee may be discounted or the advertisement price may be increased by an amount predetermined by a content provider (or system developer).

In another embodiment, the history in terms of payment made by a user may be described in the user profile table 300 so that the user can check the payment made in the past. When the user checks the past payment, the user may easily set the maximum payment value via a user interface such as a slide bar.

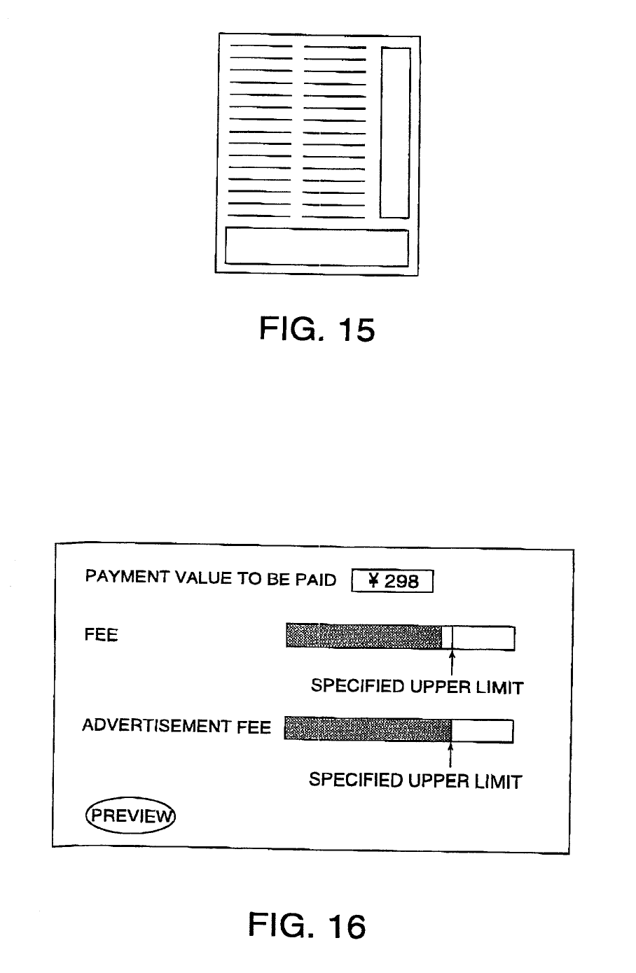

In another embodiment, a user interface such as a slide bar is provided for setting or modifying in real time the maximum payment value or the maximum advertisement fee. For example, when a digital content such as that shown in FIG. 15 is provided, the fee to be paid, the current maximum payment value and maximum advertisement fee specified by the user are displayed on a screen as shown in FIG. 16. Herein, it is possible to change the maximum value for the content fee or the advertisement fee by moving the slide bar. If a “Apply” button is clicked thereafter, the content of the user profile table 300 is changed in real time. In accordance with the modified content of the user profile table 300, a digital content is again produced, and the resultant digital content can be pre-viewed. This makes it possible to produce a digital content that meets the desire of the user to a further higher extent.

In the embodiments described above, the processes described in the flow charts shown in FIGS. 8 and 9 are performed by executing the control program that has been stored in advance in the ROM 32. Alternatively, a program indicating a procedure to be executed may be read from a storage medium to be stored into the RAM 34, and then to be executed. The program to be executed may be downloaded via a network.

Herein, any storage medium may be employed whether the storage medium is of any type that is electronically, magnetically, or optically read, as long as the storage medium is readable by a computer. Specific examples of storage media includes a semiconductor storage medium such as a RAM and a ROM, a magnetic storage medium such as an FD and an HD, an optical storage medium such as a CD, a CDV, a LD, and a DVD, and magnetooptical storage medium such as a MO.

In the embodiments described above, the debt distribution system, the billing system, the debt distribution method, and the storage medium, for use in the content distribution service, according to the present invention is applied to the networked system including the Internet 199. Such systems according to the present invention may also be applied to an intra-network system based on the same communication scheme as that of the Internet 199. Of course, other types of usual network systems based on a communication scheme different from that of the Internet 199 may also be employed.

In the embodiments described above, the debt distribution system, the billing system, the debt distribution method, and the storage medium, according to the present invention are used to provide the content distribution service in which, as shown in FIG. 1, the content distribution terminal 100 distributes digital contents concerning news or the like together with advertisement information offered by an advertiser to user terminals 200. The debt distribution system, the billing system, the debt distribution method, and the storage medium may also be used in a wide variety of manners without departing from the scope of the present invention.

[Advantages]

As described above, the debt distribution system in the content distribution service according to claim 1 of the present invention provides an advantage over the conventional technologies in that digital contents can be provided to individual users in accordance with the methods of imposing the debt and the digital content selection conditions specified by the respective users while reducing a possibility that an unexpectedly high fee is charged to the users.

The billing system in the content distribution service according to one of claims 2 to 11 of the present invention provides an advantage over the conventional technologies in that digital contents can be provided to individual users in accordance with the methods of charging the fee and the digital content selection conditions specified by the respective users while reducing a possibility that an unexpectedly high fee is charged to the users.

The billing system in the content distribution service according to claim 9 of the present invention provides a further advantage that digital contents can be outputted in an output layout specified by a user so that the user can view the digital contents laid out in a manner desirable for the user.

The billing system in the content distribution service according to claim 10 of the present invention provides a further advantage that a user can know the debt distribution result thereby providing great convenience to the user.

The billing system in the content distribution service according to claim 11 of the present invention provides a further advantage that a digital content can be produced in accordance with a desire of an user.

The debt distribution method in the content distribution service according to claim 12 of the present invention provides a similar advantage to that achieved by the debt distribution system in the content distribution service according to claim 1.

The storage medium in which the debt distribution program in the content distribution service is stored, according to claim 13 of the present invention, provides a similar advantage to that achieved by the debt distribution system in the content distribution service according to claim 1.

What is claimed is:

1. A system for distributing a debt in a content providing service, the system being communicably connected to content storage means in which one or more digital contents are stored and also communicably connected to additional-information storage means in which additional information offered for being provided by one or more additional-information providers is stored, the system having a capability of distributing a debt such that when additional information is transmitted to an user associated with a digital content, part or all of a debt imposed upon the user as a result of transmission of the digital content to the user is distributed to the additional-information provider of the additional information,
wherein the digital content and the additional information are selected from the content storage means and the additional-information storage means in accordance with a selection criterion, in terms of the debt distribution, designated by the user, and part or all of the debt imposed upon the user is distributed to the additional-information provider in accordance with the selection result.

2. A billing system for use in a content providing service, the system being communicably connected to content storage means in which one or more digital contents are stored and also communicably connected to additional-information storage means in which additional information offered for being provided by one or more additional-information providers is stored, the system having a capability of distributing a payment value such that when additional information is transmitted to an user associated with a digital content, part or all of the payment value charged to the user as a result of transmission of the digital content to the user is distributed to the additional-information provider of the additional information, the system comprising:
distribution-manner information storage means for storing distribution-manner information indicating a manner of distributing the payment value, designated by the user;
content selection means for selecting a digital content from the digital contents stored in the content storage means;
additional-information selection means for selecting additional information from the additional information stored in the additional-information storage means;
additional-information linkage means for making a link between the digital content selected by the content selection means and the additional information selected by the additional-information selection means;
content transmission means for transmitting the digital content linked to the additional information to the user; and
payment value distribution means for distributing part or all of the payment value charged to the user to the additional-information provider, in accordance with the selection result made by the content selection means and in accordance with the selection result made by the additional-information selection means,
wherein one or both of the content selection means and the additional-information selection means make a selection in accordance with the distribution-manner information stored in the distribution-manner information storage means and in accordance with a selection result made by the other one of the content selection means and the additional-information selection means.

3. A billing system for use in a content distribution service according to claim 2, wherein
the content storage means stores the digital content such that the digital content is related to digital-content-fee information indicating a fee for the digital content to be paid by the user,
the additional-information storage means stores the additional information such that the additional information is related to discount value information indicating a discount value that will be reduced from the payment value when the additional information is linked to the digital content,
wherein one or both of the content selection means and the additional-information selection means make a selection such that the sum of the fee calculated on the basis of the digital-content-fee information or the discount value information corresponding to a selection result made by the other one of the content selection means and the additional-information selection means in accordance with the distribution-manner information stored in the distribution-manner information storage means and the fee calculated on the basis of the discount value information or the digital-content-fee information corresponding to a selection result made by the user meets a condition specified by the user.

4. A billing system for use in a content distribution service according to claim 3, wherein
the distribution-manner information is information indicating a maximum value in terms of the payment value designated by the user, and
wherein the content selection means selects the digital content such that the fee calculated on the basis of the digital-content-fee information corresponding to the digital content to be selected by the content selection means does not become greater than the sum of the maximum value indicated by the distribution-manner information and the discount value calculated on the basis of the discount value information corresponding to the additional information selected by the additional-information selection means.

5. A billing system for use in a content distribution service according to claim 3, wherein
the distribution-manner information is information indicating a maximum value in terms of the payment value designated by the user, and
wherein the additional-information selection means selects the additional information such that the fee calculated on the basis of the digital-content-fee information corresponding to the digital content selected by the content selection means does not become greater than the sum of the maximum value indicated by the distribution-manner information and the discount value calculated on the basis of the discount value information corresponding to the additional information to be selected by the additional-information selection means.

6. A billing system for use in a content distribution service according to claim 4 or 5, further comprising
fee calculation means for calculating the fee on the basis of the digital-content-fee information corresponding to the digital content selected by the content selection means; and
discount value calculation means for calculating the discount value on the basis of the discount value information corresponding to the additional information selected by the additional-information selection means,
wherein the content selection means selects the digital content such that the fee calculated on the basis of the digital-content-fee information corresponding to the digital content to be selected by the content selection means does not become greater than the sum of the maximum value indicated by the distribution-manner information and the discount value calculated by the discount value calculation means, and
the additional-information selection means selects the additional information such that the fee calculated by the fee calculation means does not exceed the sum of the maximum value indicated by the distribution-manner information and the discount value calculated on the basis of the discount value information corresponding to the additional information to be selected by the additional-information selection means.

7. A billing system for use in a content distribution service according to one of claims 3 to 6, wherein
the distribution-manner information is information indicating a selection condition in terms of the additional information designated by the user,
the additional-information selection means selects additional information that meets the selection condition indicated by the distribution-manner information, and
the fee distribution means determines the payment value to be paid by the user by subtracting the discount value calculated on the basis of the discount value information corresponding to the additional information selected by the additional-information selection means from the fee calculated on the basis of the digital-content-fee information corresponding to the digital content selected by the digital content selection means.

8. A billing system for use in a content distribution service according to one of claims 3 to 7, wherein
the distribution-manner information is information indicating a digital content selection condition specified by the user,
the content selection means selects a digital content that meets the selection condition indicated by the distribution-manner information, and
the fee distribution means determines the payment value to be paid by the user by subtracting the discount value calculated on the basis of the discount value information corresponding to the additional information selected by the additional-information selection means from the fee calculated on the basis of the digital-content-fee information corresponding to the digital content selected by the digital content selection means.

9. A billing system for use in a content distribution service according to one of claims 2 to 8, further comprising
user information storage means for storing user information associated with a user, and
content layout means for determining an output layout of the digital content linked to the additional information, in accordance with the user information stored in the user information storage means, and laying out the digital content in accordance with the determined output layout,
wherein the content distribution means transmits a digital content laid out by the layout means to the user.

10. A billing system for use in a content distribution service according to one of claims 2 to 9, further comprising distribution-result providing means for providing a distribution result made by the fee distribution means to the user.

11. A billing system for use in a content distribution service according to claim 10, further comprising
modify command input means for inputting a modify command to modify the distribution-manner information in response to the distribution result provided by the distribution-result providing means; and
distribution information modifying means for modifying the distribution-manner information stored in the distribution-manner information storage means in accordance with the modify command inputted via the modify command input means.

12. A method of distributing a debt for use in a content distribution service such that when additional information offered for being provided by an additional-information provider is transmitted to a user associated with a digital content, part or all of a debt imposed upon the user as a result of transmission of the digital content to the user is distributed to the additional-information provider, the method comprising the steps of:
selecting a digital content and additional information from digital contents and additional information respectively stored in content storage means and additional-information storage means in accordance with a selection criterion, in terms of the debt distribution, designated by the user; and
distributing part or all of the debt imposed upon the user to the additional-information provider in accordance with the selection result.

13. A computer-readable storage medium in which is stored a debt distribution program for controlling a computer to execute a process of distributing a debt such that when additional information offered for being provided by an additional-information provider is transmitted to a user associated with a digital content, part or all of a debt imposed upon the user as a result of transmission of the digital content to the user is distributed to the additional-information provider, the process comprising the steps of:
selecting a digital content and additional information from digital contents and additional information respectively stored in content storage means and additional-information storage means in accordance with a selection criterion, in terms of the debt distribution, designated by the user; and
distributing part or all of the debt imposed upon the user to the additional-information provider in accordance with the selection result.
